(19) United States
(12) Patent Application Publication
(10) Pub. No.: US 2017/0282308 A1
(43) Pub. Date: Oct. 5, 2017

(54) VACUUM-BASED WELD FIXTURE AND METHOD OF USING THE SAME

(71) Applicant: Shiloh Industries, Inc., Valley City, OH (US)

(72) Inventor: Michael Tymosch, North Royalton, OH (US)

(21) Appl. No.: 15/478,760

(22) Filed: Apr. 4, 2017

Related U.S. Application Data
(60) Provisional application No. 62/318,075, filed on Apr. 4, 2016.

(51) Int. Cl. B23K 37/04; B23K 31/02

(52) U.S. Cl. CPC B23K 37/0408; B23K 31/02; B23K 2201/006

(57) ABSTRACT

A vacuum-based weld fixture includes a first work piece support for supporting a first work piece and a second work piece support for supporting a second work piece. The first work piece support may be slidable with respect to the second work piece support, and configured to supply a vacuum to the first work piece via at least one opening formed in a work piece support surface. The weld fixture includes a gage bar for aligning the first and second work pieces. Reduced pressure created by a vacuum source may be communicated to the opening in the work piece support surface, thereby holding the first work piece in place while the first work piece is aligned against the gage bar prior to welding.

### CROSS-REFERENCE TO RELATED APPLICATIONS

This application claims priority to U.S. Provisional Patent Application Ser. No. 62/318,075, filed on Apr. 4, 2016, the contents of which are hereby expressly incorporated by reference in their entirety.

### FIELD

The present disclosure relates to welding fixtures, and more particularly to fixtures used in laser welding operations.

### BACKGROUND

Tailor welded blanks, such as those used in automotive or vehicle applications, may be joined using welding techniques such as laser welding. Typically, work pieces being welded or joined must be restrained in a weld fixture. Precision joining processes such as laser welding typically require relatively stable fixtures, in order to maintain work pieces in consistent position with respect to each other during the joining process. Once the work pieces are appropriately restrained, the pieces may be joined together, thereby generally permanently fixing the work pieces together in a single piece. Alignment of the work pieces is also important to production of high quality weld joints between work pieces.

In some known approaches, steel work pieces are retained using a magnetic fixture, which generally holds work pieces in place as a result of an applied magnetic force. These approaches do not work with non-magnetic materials, such as aluminum.

Accordingly, there is a need for an alternative approach to fixturing of work pieces, which is more broadly applicable to alternative work piece materials and capable of retaining the work pieces in an aligned configuration appropriate for laser welding.

### DRAWINGS

FIG. 1 is a perspective view of an exemplary weld fixture;

FIG. 2 is a side view of the exemplary weld fixture of FIG. 1;

FIG. 3 is a perspective view of the exemplary weld fixture of FIG. 1 with one work piece positioned thereon;

FIG. 4 is a perspective view of the exemplary weld fixture of FIG. 1 with a second work piece positioned adjacent the first work piece;

FIG. 5A is an enlarged section view of an example vacuum-based fixture having a gasket;

FIG. 5B is an enlarged perspective view of the vacuum-based fixture gasket of FIG. 5A;

FIG. 5C is a section view of an exemplary vacuum-based fixture having a plurality of gaskets in a work piece support; and

FIG. 6A is an enlarged section view of another example vacuum-based fixture;

FIG. 6B is an enlarged perspective view of the vacuum-based fixture of FIG. 6A;

FIG. 7A is an enlarged view of a gage bar shown in the exemplary weld fixture of FIG. 2, with the gage bar positioned between two work pieces;

FIG. 7B is an enlarged view of a gage bar shown in the exemplary weld fixture of FIG. 2, with the gage bar shown in a lowered position beneath the two work pieces;

FIG. 8 is a process flow diagram for an exemplary method of securing work pieces to a fixture.

### DESCRIPTION

Exemplary illustrations are provided herein of a welding fixture, e.g., for use in a laser welding operation. One or more work piece supports may be provided to handle work pieces and positioning of the same with respect to other work pieces. Exemplary work piece supports may selectively place a reduced pressure from a low-pressure source or vacuum in fluid communication with a work piece, thereby allowing the fixture to selectively grip the work piece. The use of a reduced pressure to selectively grip work pieces advantageously allows the fixture to be used for welding of virtually any material that is susceptible to welding, including those made of aluminum and aluminum alloys. Example work piece supports may selectively apply vacuum or reduced pressure to a work piece by way of openings in a support surface of the work piece. The openings may be included in one or more vacuum pads of the work piece support.

As will be described further below, an exemplary weld fixture may include a first work piece support for supporting a first work piece and a second work piece support for supporting a second work piece. The first work piece support may be slidable with respect to the second work piece support, and may be configured to supply a reduced pressure from a vacuum or reduced pressure source to an underside of the first work piece via an opening in a work piece support surface. The weld fixture may also include a gage bar for aligning the first and second work pieces. Reduced pressure created by a vacuum source may be communicated to the opening in the work piece support surface so that the first work piece support holds it in place while the gage bar is moved from between the first and second work pieces.

In some examples, vacuum may be applied to a work piece via one or more openings in a work piece support surface, with the work piece being retained and in contact with the work piece support surface. The work piece support surface may include a plurality of vacuum “pads” configured to contact the work piece which are relatively small in comparison to the fixture and/or the work piece support. Alternatively, the work piece(s) may be supported by a relatively larger, generally continuous work piece support surface, in which openings are formed that are configured to communicate a reduced pressure or vacuum to a work piece. In some examples, a gasket may be provided that generally surrounds an opening formed in a work piece support surface, with the gasket providing a seal surface, e.g., by way of a relatively compliant material, thereby increasing effective suction applied by the work piece support to the work piece. In other examples, gaskets may not be necessary or desirable, e.g., where adequate vacuum is communicated to a work piece without the gasket.

Exemplary methods of using a vacuum-based weld fixture are also disclosed. In one exemplary illustration, a method includes securing a first work piece on a first work piece support using a vacuum source, and securing a second work piece on a second work piece support. The method may further include pushing the first and second work pieces towards a gage bar located between the first and second work pieces until contact is made, and lowering the gage bar so that the gage bar is no longer located between the first and second work pieces. The method also includes sliding the first work piece support with the vacuum secured first work piece towards the second work piece support with the secured second work piece until contact is made, at which point the first and second work pieces are aligned along their respective edges.

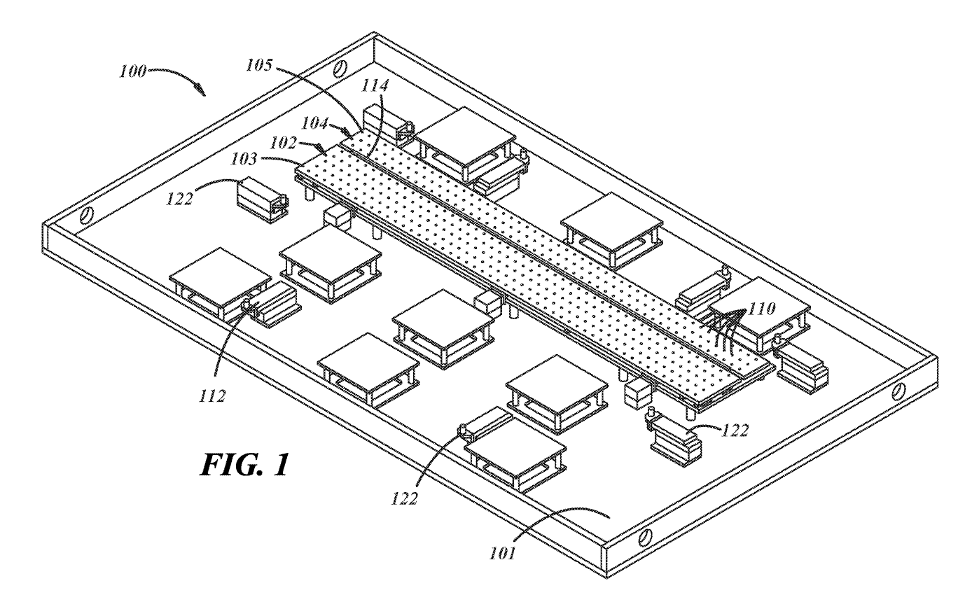

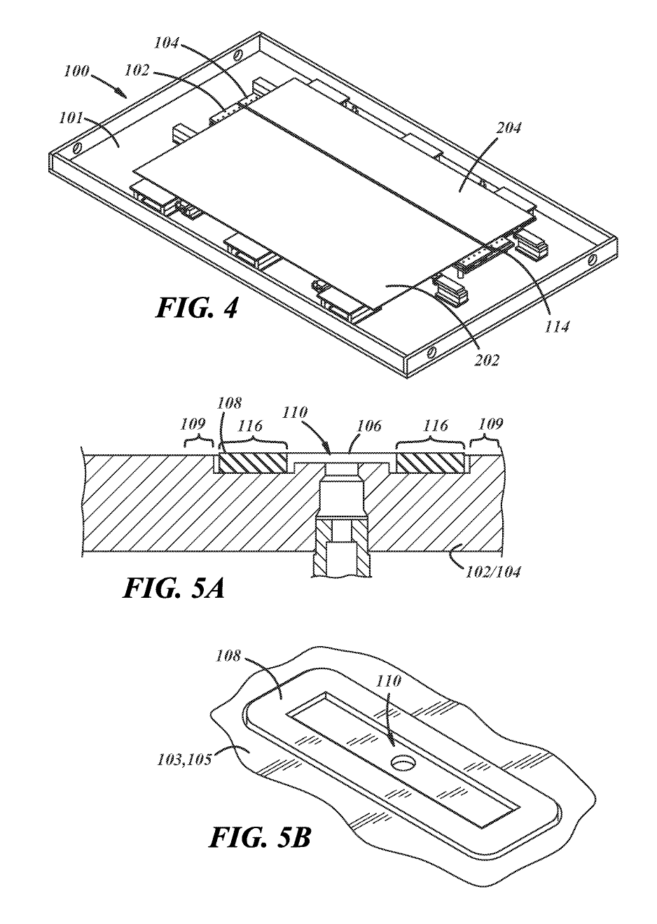

Turning now to FIGS. 1-8, an exemplary weld fixture 100 is illustrated and described in further detail. Weld fixture 100 includes first and second work piece supports 102, 104, each of which are supported by a base 101 of the fixture 100. The first and second work piece supports 102, 104 may support corresponding first and second work pieces 202, 204, e.g., as shown in FIG. 4. For example, the supports 102, 104 may position the first and second work pieces 202, 204 in contact with each other to facilitate welding the first and second work pieces 202, 204 together along edges thereof. In some exemplary approaches, the work pieces 202, 204 may be abutted together along facing edges, thereby facilitating the creation of a butt joint between the work pieces 202, 204. In this manner, a welded blank, e.g., a tailor welded blank, may be formed by the joining of the first and second work pieces 202, 204. Alternatively, other types of weld joints may be formed, including lap joints, combination butt and lap joints, joints between similar or dissimilar gauge material, joints between similar or dissimilar metals, etc.

While two work pieces 202, 204 are illustrated in the examples that follow, these are merely examples and it will be understood that more than two work pieces may be joined in a variety of arrangements. Merely as one example, two or more work pieces may be joined along a single edge of a third work piece. Additionally, while the work pieces 202, 204 are illustrated as having a generally similar length along the joined edges thereof, work pieces being joined may have different lengths.

The work pieces 202, 204 may be formed of any material that is convenient. Moreover, as described further below the exemplary fixture 100 is not limited to ferrous materials, or for that matter any particular material type.

The work pieces 202, 204 may also have any size and/or thickness that is convenient. The illustrated examples below show the work pieces 202, 204 as having a sheet configuration. Other configurations, e.g., non-flat, non-planar work pieces, may be employed. In one example, a work piece may be a steel sheet having a thickness of approximately 0.5 millimeters to 2.5 millimeters. In another example, a work piece may be an aluminum sheet having a thickness of approximately 1.0 millimeters to 2.0 millimeters.

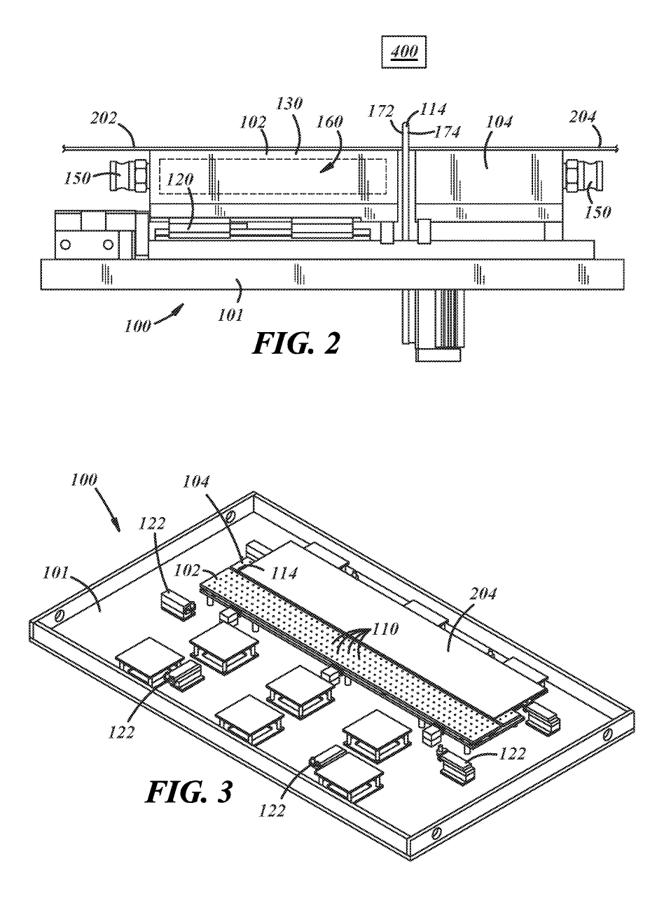

The first and second work piece supports 102, 104 may be moveable with respect to each other. More specifically, as best seen in FIG. 2, the first work piece support 102 may be slidable with respect to the second work piece support 104. As will be described further below, relative motion between the first and second work piece supports 102, 104 may be used to move the work pieces 202, 204 into contact to facilitate welding the work pieces 202, 204 together. While the exemplary illustrations herein are directed to an arrangement where the first work piece support 102 is slidable along a base 101 of the fixture 100 and the second work piece support 104 is generally fixed to the base 101, any other approach providing relative motion between the first and second work pieces 202, 204 may be used. Merely as examples, the second work piece support 104 may be moveable along the base 101, or both the first and second work piece supports 102, 104 may be moveable along the base 101. The work piece supports 102, 104 may be formed of any materials that are convenient, e.g., steel, aluminum, or synthetic materials, merely as examples.

As best seen in FIG. 2, the first work piece support 102 may translate with respect to the base 101 along a rail 120. The rail 120 may be positioned such that the first work piece support 102 generally slides along the rail 120 in a direction perpendicular or substantially so with respect to the facing edges of the first and second work pieces 202, 204. Moreover, the rail 120 may generally limit motion of the first work piece support 102 to a translational motion that is parallel or substantially so with respect to the base 101. As will be described further below, the rail 120 may facilitate a relatively short lateral movement of the first work piece 202 toward the second work piece 204 after the first and second work pieces 202, 204 are aligned with each other, thereby bringing the facing edges of the work pieces 202, 204 into abutting contact. In examples where the second work piece support 104 is moveable with respect to the base 101, any relative movement mechanism such as the rail 120 may be provided to facilitate movement or sliding of the second work piece support with respect to the base 101.

The first work piece support 102 and second work piece support 104 may each use a vacuum or reduced pressure source to selectively grasp or grip the associated work piece. As noted above, the use of a vacuum source allows the work piece supports 102 and/or 104 to grip a work piece formed of virtually any type of material including non-ferrous metals like aluminum. Accordingly, the fixture 100 may be used to weld work pieces formed of any material susceptible to welding. Another advantageous aspect of the vacuum-based approach is reduced cycle times, which may result from the relative speed with which vacuum or reduced pressure is created, which in turns facilitates the work piece support 102 and/or 104 gripping a work piece. Additionally, release of the work piece may be facilitated by reversing pressure applied to the work piece, thereby “blowing off” the work piece to an extent which allows for quickly releasing the work piece while not damaging the formed work piece.

As best seen in FIG. 1, the first and second work piece supports 102, 104 may each have a plurality of openings 110 in respective work piece support surfaces 103, 105. use of a relatively large number of openings 110 on a work piece support 102 and/or 104, e.g., as shown in FIG. 1, may allow a relatively large gripping force to be applied across a large surface area or length of a work piece, thereby drawing the work piece against the associated work piece support surface 103, 105. As such, the openings 110 may provide a relatively stable and secure positioning of a work piece.

In some approaches, openings 110 may be relatively small and numerous, thereby spreading application of reduced pressure applied to work piece 202/204 across a relatively large portion of the work piece. Merely as examples, the openings may define a relatively small diameter, e.g., of no more than 10 millimeters. In another example, a relatively large number of openings, e.g., at least twenty (20), may be provided per square foot of the work piece support surface 103/105.

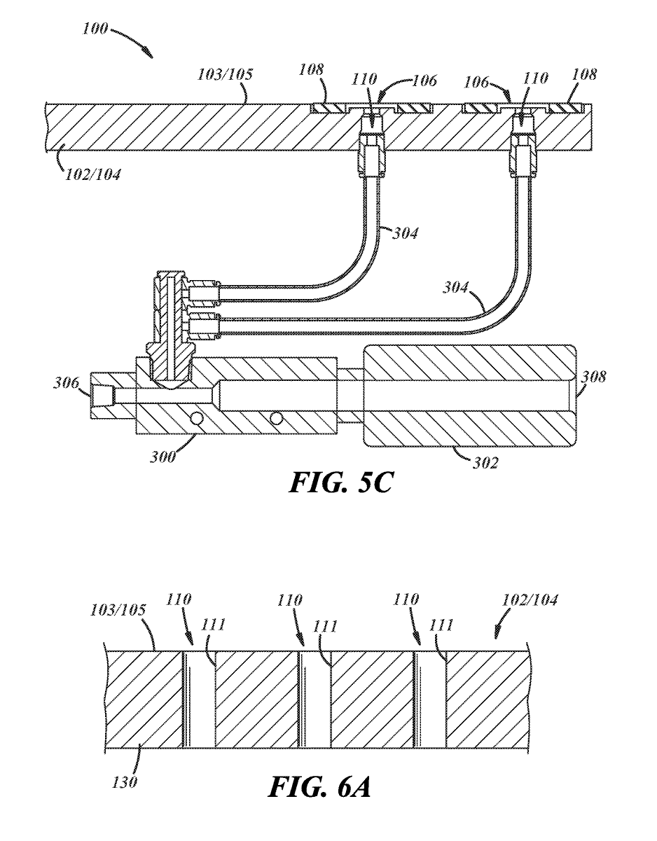

Turning now to FIGS. 5A, 5B, and 5C, in some approaches a plurality of vacuum pads 106 may be provided on a work piece support surface 103, 105 of work piece support 102, 104. Example vacuum pads 106 may have a seal surface extending about an opening 110 in the work piece support 102, 104. The seal surface may generally be configured to interface against an underside of the work pieces 202 and/or 204, thereby providing a seal about the opening 110 which facilitates application of suction to the work pieces 202 and/or 204.

In some examples, the seal surface may be defined by a gasket. For example, as best seen in FIGS. 5A, 5B, and 5C, each vacuum pad 106 may include a gasket 108 that is positioned about opening 110 in the work piece support 102, 104. The opening 110 may be in fluid communication with a vacuum or low pressure source 300. In other examples, a vacuum or low pressure may be provided by a regenerative pump. The gasket 108 may be positioned in a recessed channel in the work piece support surface 103/105. For example, the gasket 108 may be positioned in a peripheral recess 116 formed in the work piece support surface 103/105. The gasket 108 and/or the peripheral recess 116 may each generally surround a perimeter of the opening 110 so as to circumscribe the opening and increasing a degree to which the gasket 108 may seal against the underside of a corresponding work piece. Accordingly, when suction or vacuum is placed in fluid communication with the opening 110 and the gasket 108 is placed against a surface of a work piece (not shown), the work piece will generally be held against the gasket 108 by the vacuum. The gasket 108 may be formed of a relatively soft or pliable material that is susceptible to sealing against the surfaces of the work pieces 202, 204. Merely as examples, a rubber, butyl, or plastic material may be used.

It should also be understood that while a single opening 110 is illustrated, e.g., in FIGS. 5A/5B/5C, in another example a single gasket 108 or seal surface 109 may surround multiple openings 110 of a similar or dissimilar size. Thus, a single vacuum pad 106 may have a plurality of associated openings 110.

In other example approaches, in contrast to those shown in FIGS. 5A/5B/5C, a gasket is not used to provide a seal surface. Examples lacking a gasket may be executed by, for example, providing openings 110 substantially as described above, but without gasket 108 and/or peripheral recess 116 surrounding the openings 110. In examples where one or more vacuum pads 106 are employed in the work piece support 102/104, a portion 109 (see FIG. 5A) of the work surface 103/105 surrounding the opening 110 may serve as the seal surface by contacting an underside of the work piece 202/204 (not shown in FIG. 5A).

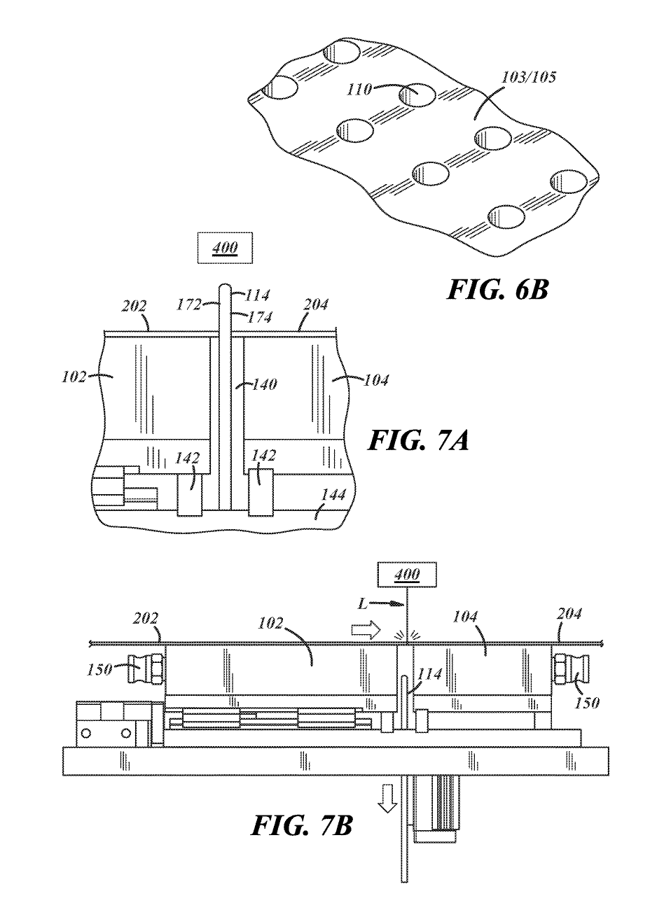

Turning now to FIGS. 6A and 6B, another example where a gasket is not used is illustrated. The work piece support 102/104 may have an upper fixture support 130, which defines work piece support surface 103/105. A plurality of openings 110 is defined in the work piece support surface 103/105. As shown in FIGS. 6A/6B, a plurality of passages 111 extend through the upper fixture support, thereby defining the openings 110 in the work piece support surface 103/105. Upper fixture support 130 may define, in part, a vacuum cavity of the work piece support 102/104 (see FIG. 1). Accordingly, the passages 111 may communicate a reduced pressure or vacuum to the openings 110, thereby drawing a work piece (not shown in FIGS. 6A/6B) down upon the work piece support surface 103/105.

As noted above, openings 110 may be relatively small and numerous, thereby spreading application of reduced pressure applied to work piece 202/204 across a relatively large portion of the work piece. The openings, for example, may define a relatively small diameter, e.g., of no more than 10 millimeters. Additionally, a relatively large number of openings may be provided, e.g., at least twenty (20), per square foot of the work piece support surface 103/105. In this manner, grip of the work piece support 102/103 applied to work piece 202/204, respectively, may be applied across a relatively large portion of a work piece. Merely as one example, grip of the work piece support 102/103 applied to work piece 202/204, respectively, may be applied across more than 50% of a length of an edge of the work piece 202/204, thereby enhancing the degree to which the work piece support 102/104 maintains an alignment of work piece 202/204 for joining, e.g., by laser welding.

A reduced pressure or vacuum may be supplied to opening(s) 110 of an exemplary work piece support 102/104 in any manner that is convenient. Merely by way of example, as best seen in FIG. 1 work piece support 102 may define an internal cavity 160, which is in fluid communication with a connector 150. The connector 150 may receive a connection, e.g., a removable connection, from a regenerative pump, a vacuum source, a reduced pressure, or the like. The reduced pressure or vacuum applied to the cavity may draw air into openings 110 and through the cavity 160 by way of the passages 111 (best seen in FIG. 6A). Accordingly, a work piece placed upon the work piece support surface 103/105 may be drawn down upon the work piece support 102/104, thereby securing the work piece to the work piece support 102/104.

In another approach shown in FIG. 5C, a vacuum source 300 may include a manifold or Venturi tunnel 302 that is in communication with the openings 110 of the vacuum pads 106, e.g., by way of flexible tubing 304. The tubing 304 may be connected at opposite ends to the vacuum pad 106 and the Venturi tunnel 302 by way of tube fittings, e.g., the branch and tube fittings shown in FIG. 7. A fluid or gas supply, e.g., an air compressor, may be connected with a supply end 306 of the Venturi tunnel 302 such that a fluid is circulated from the supply end, through the Venturi tunnel, and out through an exhaust end 308. The tubing 304 is connected to the Venturi tunnel in between the supply and exhaust ends 306, 308, such that a vacuum flow is created through the tubing 304 from the opening 110. While the tubing 304 is illustrated connecting two vacuum pads 106 with the vacuum source 300, additional tubing may be provided to connect a larger number of vacuum pads 106 with the vacuum source. Accordingly, a manifold may connect any number of vacuum pads 106, and the openings 110 thereof, with a vacuum source that is convenient.

Turning now to FIGS. 1-4, 7A, and 7B, the weld fixture 100 may include a gage bar 114 for aligning the first and second work pieces 202, 204. The gage bar 114 may be positioned between the first and second work pieces 202, 204, thereby defining a gap therebetween and facilitating alignment of the first and second work pieces 202, 204 with each other. As best seen in FIGS. 2 and 7A, the gage bar 114 may have a first alignment surface 172 and a second alignment surface 174. The alignment surfaces 172, 174 may generally be planar, facilitating alignment of respective edges of work pieces 202, 204 when the edges of the work pieces 202, 204 are pushed against the gage bar 114. The gage bar 114 may translate or move vertically up and down with respect to the work pieces 202, 204, thereby allowing the first and second work pieces 202, 204 to be brought into contact together along facing edges of the first and second work pieces, as will be described further below. In one embodiment, the gage bar 114 retracts from an extended alignment position, in which the gage bar 114 is positioned between the work pieces 202, 204 and positioned to allow alignment of the edges thereof, to a retracted welding position, in which the gage bar 114 is positioned beneath the work pieces. The gage bar 114 may retract into an exhaust gas chamber 140 located beneath the interface of the work pieces being welded.

The gage bar 114 may be configured to align opposing edges of the first and second work pieces 202, 204. In one example, the work piece support surfaces 103/105 may collectively exert sufficient grip upon the first and second work pieces 202, 204 with the vacuum/reduced pressure supplied via the opening(s) 110, such that the work pieces 202, 204 remain aligned for joining after the gage bar 114 is removed from between the first and second work pieces 202, 204. Alternatively, to facilitate continued alignment of the work pieces 202, 204 while in contact with the gage bar 114, it may be desirable to have a shear force imparted by the gage bar 114 to each work piece 202, 204 slightly exceed a vacuum force exerted on the work pieces 202, 204. As such, contact with the gage bar 114 may allow the work pieces 202, 204 to be moved slightly with respect to the work piece support 102/104 to correct small misalignments, while still allowing sufficient grip upon the work pieces 202, 204 to prevent large movements thereof that would misalign the work pieces 202, 204.

The weld fixture 100 may further include one or more auxiliary pushers 122, which are used to move the first and second work pieces 202, 204 into contact after the gage bar 114 drops down. For example, auxiliary pushers 122 each may push the first work piece 102 and the first work piece support 102 such that they slide together towards the gage bar 114 as permitted by the rail 120 supporting the first work piece support 102. The auxiliary pusher(s) 122 may thereby push the aligned first work piece 202 into abutting contact with the second work piece 204. As the auxiliary pusher 122 moves the first work piece 202 toward the second work piece 204, the first work piece support 102 may maintain suction/vacuum, thereby keeping the first work piece 202 fixed to the first work piece support 102. Accordingly, movement of the first work piece 202 is generally permitted by the sliding first work piece support 102 as it moves along the rail 120. In addition to positioning the work pieces 202, 204 before welding, the auxiliary pushers 122 may also exert a force (which may be relatively small, e.g., 25-30 psi, or a force less than 10 pounds) on the work pieces during welding so they are urged together as the weld joint is formed.

Turning now to FIGS. 7A and 7B, an exemplary welding process that may be used to join the first and second work pieces 202, 204 is described in further detail. In FIG. 7A, the gage bar 114 remains interposed between the first and second work pieces 202, 204, such that the adjacent edges of the first and second work pieces 202, 204 are aligned with one another but not in contact with one another. More specifically, the edges of the work pieces 202, 204 are abutted against their respective alignment surfaces 172, 174 of the gage bar 114. The gage bar 114 may drop down, initially leaving a gap between the adjacent aligned edges of the first and second work pieces 202, 204. The auxiliary pusher(s) 122 may then urge the first and second work pieces 202, 204 into contact over the recessed gage bar 114 as shown in FIG. 7B. More specifically, the auxiliary pusher(s) 122 may slide the first work piece support 102 and first work piece 202 laterally, bringing the adjacent edges of the first and second work pieces 202, 204 together to form a butt joint. A laser head 400 may be positioned near the first and second work pieces 202, 204, e.g., above the first and second work pieces 202, 204. The laser head 400 may then aim a laser L (see FIG. 7B) along or adjacent the edges of the first and second work pieces 202, 204, thereby welding them together to form a single unitary piece. Skilled artisans will appreciate that the specific type or number of laser head(s), as well as its orientation or distance relative to the work pieces 202, 204, will be dictated by a number of factors and that the weld fixture described herein is not limited to any particular laser head embodiment.

An exhaust gas chamber 140, also referred to as a beam dump, may be disposed beneath the first and second work pieces 202, 204, opposite the laser head 400 that is positioned above the work pieces 202, 204. During the welding process, it may be convenient to supply shielding gas along the adjacent edges of the first and second work pieces 202, 204. Merely as one example, the exhaust gas chamber 140 may be supplied with an inert gas, such as argon, which can help reduce porosity when welding aluminum. An inert exhaust gas may generally minimize unintended reactions of the first and second work pieces 202, 204 during the welding process. According to the embodiment of FIGS. 7A and 7B, the exhaust gas chamber 140 is defined by a pair of vertical supports 142, a horizontal support or platform 144, and the underside of the two work pieces 202, 204. Other exhaust gas chamber configurations are certainly possible.

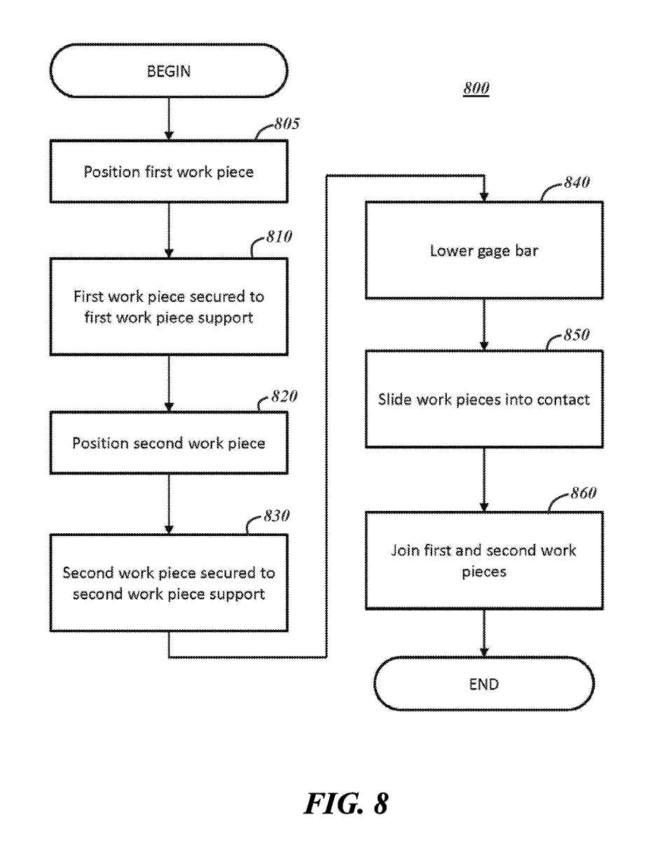

Turning now to FIG. 8, a process 800 is illustrated for positioning and/or joining first and second work pieces together, e.g., for welding. Process 800 may begin at block 805, where a first work piece is positioned or aligned on first work piece support. In a tailor welded blank having work pieces with dissimilar thicknesses, the thicker piece is preferably positioned and secured first. As described above, a first work piece 202 may be laid upon a first work piece support 102. The first work piece 202 may be positioned on the first work piece support 102 and aligned for being joined, e.g., via welding, to the second work piece 204 in any manner that is convenient. In one example, one or more gage pins are provided on the first work piece support 102 which engage an edge of the first work piece 202, e.g., one of the lateral edges not being welded to the second work piece 204, thereby aligning the lateral edge of the first work piece 202 with the gage pins. The gage pins may thereby align the first work piece 202 in an “x” direction, i.e., parallel to the weld edge.

As part of the alignment and/or positioning of the first work piece 202, the first work piece may also be aligned in a “y” direction, i.e., perpendicular to the weld edge, by pushing the first work piece 202 towards a gage bar located until contact is made. For example, when the first work piece 202 is loaded onto the first work piece support 102, the first work piece 202 may be pushed against gage bar 114, thereby generally aligning the edge of the first work piece 202. The work piece 202 may thereby be aligned in a first dimension by the gage bar 114, and in a second dimension by the gage pins.

Proceeding to block 810, the work piece 202 may be secured to the first work piece support, e.g., with the use of a vacuum source or reduced pressure. As described above, a first work piece support 102 may grasp a work piece 202. Reduced pressure created by, for example, a vacuum source 300 or regenerative pump, may be communicated to an opening 110 in the work piece support surface 103 so that first work piece 202 is drawn against work piece support surface 103, thereby holding the first work piece 202 in place. The first work piece 202 is thus aligned with the gage bar 114 and secured to the first work piece support 102. Process 800 may then proceed to block 820.

At block 820, a second work piece may be positioned or aligned on the second work piece support. For example, as described above a second work piece 204 may be laid upon a second work piece support 104. The second work piece 204 may be positioned on the second work piece support 104 and aligned in two dimensions in a similar fashion as described above regarding the alignment of the first work piece 202. More specifically, one or more gage pins may be provided for aligning a non-weld edge of the second work piece 204 in a first direction, while the second work piece 204 may be pushed into contact with the gage bar 114 along the weld edge. The gage bar 114 may define a constant or substantially constant thickness, such that the weld edges of the first and second work pieces 202, 204 are parallel or otherwise aligned for joining, e.g., via a welding operation. Process 800 may then proceed to block 830.

At block 830, the second work piece may be secured to the second work piece support. For example, as described above, a second work piece 204 may be secured to a second work piece support 104 by way of a vacuum source or reduced pressure applied by way of one or more openings 110. Alternatively, a standard non-vacuum method may be used to secure the second work piece 204, e.g., using a magnetic device(s) or clamp(s). Accordingly, both the first and second work pieces 202, 204 are aligned parallel to one another and secured to their respective first and second work piece supports 102, 104. Process 800 may then proceed to block 840.

At block 840, the gage bar may be lowered so that the gage bar is no longer located between the first and second work pieces. For example, gage bar 114 may be lowered such that a gap is defined between the adjacent edges of the first and second work pieces 202, 204, which are preferably parallel and aligned with one another. Process 800 may then proceed to block 850.

At block 850, the first work piece support may slide with the vacuum secured first work piece towards the second work piece support with the secured second work piece until contact is made. For example, the auxiliary pusher(s) 122 may urge the first work piece 102 and/or first work piece support 202 toward the second work piece 104 and/or second work piece support 204, respectively. Upon contact between the first and second work pieces 202, 204, the first and second work pieces 202, 204 are aligned along their respective edges and located adjacent such that they are positioned for being joined together, e.g., via welding.

Proceeding to block 860, the first and second work pieces may be welded together. For example, as described above a laser head 400 may be used to laser weld the first and second work pieces 202, 204. During the welding process, an exhaust gas may be circulated in an exhaust gas chamber, e.g., chamber 140, adjacent the weld site. It is possible the exhaust gas chamber 140 could utilize the reduced pressure created by vacuum source 300 to help remove the exhaust gases.

It is to be understood that the foregoing description is not a definition of the invention, but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A vacuum-based weld fixture, comprising:
a first work piece support for supporting a first work piece, the first work piece support includes a work piece support surface with at least one opening, the first work piece support is configured so that reduced pressure is supplied from a vacuum source through the opening in the work piece support surface to an underside of the first work piece;
a second work piece support for supporting a second work piece, the first work piece support is slidable with respect to the second work piece support; and
a gage bar for aligning the first and second work pieces, the gage bar includes a first alignment surface for aligning an edge of the first work piece and a second alignment surface for aligning an edge of the second work piece, the gage bar is movable between an extended alignment position and a retracted welding position;
wherein the vacuum-based weld fixture is configured so that the first work piece is held in place against the work piece support surface by the reduced pressure while the gage bar is moved from the extended alignment position to the retracted welding position.

2. The vacuum-based weld fixture of claim 1, wherein the gage bar is configured to define a horizontal gap between the edges of the first and second work pieces.

3. The vacuum-based weld fixture of claim 1, further comprising at least one auxiliary pusher configured to move one of the first and second work pieces toward the other of the first and second work pieces.

4. The vacuum-based weld fixture of claim 1, further comprising an exhaust gas chamber positioned between the first and second work piece supports and below the gage bar, the exhaust gas chamber is configured to supply an inert gas along the edges of the first and second work pieces.

5. The vacuum-based weld fixture of claim 1, wherein the at least one opening includes a plurality of openings formed in the work piece support surface.

6. The vacuum-based weld fixture of claim 5, wherein the first work piece support includes an upper fixture support that includes the work piece support surface, the upper fixture support defines a plurality of passages, and each of the passages extends to a respective one of the openings in the work piece support surface.

7. The vacuum-based weld fixture of claim 5, wherein the first work piece support defines a vacuum cavity in communication with the plurality of openings, and wherein the first work piece support includes a vacuum connector configured to selectively connect to the vacuum source, the vacuum connector in communication with the vacuum cavity.

8. The vacuum-based weld fixture of claim 5, wherein a diameter of each of the openings is no greater than 10 millimeters.

9. The vacuum-based weld fixture of claim 5, wherein the plurality of openings define a matrix on the work piece support surface, the matrix defines an arrangement of at least twenty openings per square foot in the work piece support surface.

10. The vacuum-based weld fixture of claim 1, wherein the first work piece support includes a gasket defining a seal surface about the at least one opening.

11. The vacuum-based weld fixture of claim 10, wherein the gasket is positioned in a peripheral recess formed in the work piece support surface.

12. A vacuum-based weld fixture, comprising:
a first work piece support for supporting a first work piece, the first work piece support includes a work piece support surface with at least one opening, the first work piece support is configured so that reduced pressure is supplied from a vacuum source through the opening in the work piece support surface to an underside of the first work piece;
a second work piece support for supporting a second work piece, the first work piece support is slidable with respect to the second work piece support;
a gage bar for aligning the first and second work pieces and moveable between an extended alignment position and a retracted welding position; and
an exhaust gas chamber positioned between the first and second work piece supports, the exhaust gas chamber is configured to supply an inert gas along the edges of the first and second work pieces;
wherein the vacuum-based weld fixture is configured so that the first work piece is held in place against the work piece support surface by the reduced pressure while the gage bar is moved from the extended alignment position to the retracted welding position.

13. The vacuum-based weld fixture of claim 12, wherein the gage bar is configured to define a horizontal gap between the edges of the first and second work pieces.

14. The vacuum-based weld fixture of claim 12, wherein the gage bar includes a first alignment surface for aligning an edge of the first work piece and a second alignment surface for aligning an edge of the second work piece.

15. The vacuum-based weld fixture of claim 12, further comprising at least one auxiliary pusher configured to move one of the first and second work pieces toward the other of the first and second work pieces.

16. The vacuum-based weld fixture of claim 12, wherein the at least one opening includes a plurality of openings formed in the work piece support surface.

17. The vacuum-based weld fixture of claim 16, wherein the first work piece support includes an upper fixture support that includes the work piece support surface, the upper fixture support defines a plurality of passages, and each of the passages extends to a respective one of the openings in the work piece support surface.

18. The vacuum-based weld fixture of claim 16, wherein the first work piece support defines a vacuum cavity in communication with the plurality of openings, and wherein the first work piece support includes a vacuum connector configured to selectively connect to the vacuum source, the vacuum connector in communication with the vacuum cavity.

19. The vacuum-based weld fixture of claim 16, wherein a diameter of each of the openings is no greater than 10 millimeters.

20. The vacuum-based weld fixture of claim 16, wherein the plurality of openings define a matrix on the work piece support surface, the matrix defines an arrangement of at least twenty openings per square foot in the work piece support surface.

21. The vacuum-based weld fixture of claim 12, wherein the first work piece support includes a gasket defining a seal surface about the at least one opening.

22. A method of using a vacuum-based weld fixture, comprising the steps of:
pushing a first work piece and a second work piece towards a gage bar until contact is made, such that the gage bar is located between the first and second work pieces, the gage bar including a first alignment surface for aligning an edge of the first work piece and a second alignment surface for aligning an edge of the second work piece;
securing the first work piece on a first work piece support with the use of a reduced pressure supplied from a vacuum source through an opening in a work piece support surface of the first work piece support to an underside of the first work piece;
securing a second work piece on a second work piece support; and
moving the gage bar from an extended alignment position to a retracted welding position so that the gage bar is no longer located between the first and second work pieces, wherein the first work piece is held in place against the work piece support surface by the reduced pressure while the gage bar is moved from the extended alignment position to the retracted welding position; and
sliding the first work piece support with the vacuum secured first work piece towards the second work piece support with the secured second work piece until contact is made, at which point the first and second work pieces are aligned along their respective edges.
